(19) United States
(12) Patent Application Publication
(10) Pub. No.: US 2017/0042079 A1
(43) Pub. Date: Feb. 16, 2017

(54) Multi-function modular soil cavity creator tool

(71) Applicant: Kenneth W. Harris, Parrish, FL (US)

(72) Inventor: Kenneth W. Harris, Parrish, FL (US)

(21) Appl. No.: 14/824,164

(22) Filed: Aug. 12, 2015

(51) Int. Cl. A01B 1/24; A01C 5/02

(52) U.S. Cl. CPC A01B 1/24; A01C 5/02

(57) ABSTRACT

A multi-function service tool capable of creating numerous size cavities in the soil with the deployment of one or more various size cavity cutters attached to the tool t-handle. This modular flexibility concept allows service technicians of various industries and others to deploy a single configured tool, that contains specific attachments, to complete their various assigned service tasks.

### FIELD OF THE INVENTION

A tool that has been designed to provide a number of different service related functions that require a cavity to be created within the soil. One function will be for the servicing of both commercial and private lawn sprinkler systems. Additionally, pest control companies need to create specific sized cavities for the in-ground installation of their termite bait stations. Other service related soil cavity creation functions include different size and types of cavities for landscape planting, gardening and the creation of a soil cavity for the special cemetery in-ground memorial holders. All of these service related functions can easily be accomplished by the creative modular design of this tool and its ability to incorporate various size soil cavity cutters.

Currently and for many years in the past the main tools for these various activities have been with shovels, post hole diggers, augers of various sizes and shapes and similar tools required to create cavities in the soil.

### BACKGROUND OF THE INVENTION

The servicing and maintenance of commercial and private in-ground lawn and landscaping sprinkler systems require a number of time consuming and tedious manual labor tasks in order to maintain the system at its specific design requirements that will ensure lawns and shrubs remain in a healthy state.

Common tasks related to the maintenance and operation of a irrigation sprinkler system are: (1) removal of all overgrowth (grass or weeds) from the top of the popup sprinkler assembly (2) eliminate sand and soil that invades the sprinkler area that prohibits its proper function, (3) installation of sprinkler head protector units (required to protect heads from lawn mowers or other machinery used in lawn care), (4) total removal of the sprinkler head assembly for rebuild, cleaning or replacement (5) insertion of the repaired/replacement sprinkler head and replacement of the soil around the head assembly and protector. Today these tasks are performed by local irrigation companies, lawn service companies, contract gardening personnel or homeowners. In today's service environment these task are generally accomplished by using a number of individual hand tools such as various size shovels, posthole diggers, augers, grass or weed trimmers or other related devices. Most are cumbersome labor intensive and create less than an acceptable appearance around the area after service is performed.

By configuring the multi-function tool utilizing (FIG. 1, components 1, 2, 3, 4) as a single tool the service personnel maintaining the sprinkler systems can accomplish the complete, range of activities noted above.

In another large industry pest control company service personnel may have the task of treating termites around small or large structures with the installation and monitoring of termite bait stations. To install the bait station the service technician must create a soil cavity at specified location around the structure. The cavities for the stations must be cut to an exact depth and diameter with a portion of the soil removed at the surface top entrance to insure the stations access top assembly is flat on the soil surface. Any deviation of these dimensions will reduce the module effectiveness. This tool allows the industry to have an absolute solution to this requirement. To accomplish this task there are several tool configurations that can be used. (FIG. 1, components 1, 2, 7) or the use of components (1, 2, 4) can be utilized depending on the specific style of bait stations. There currently are three types of stations with two cutter sizes. Today these service personnel employ different shovel types, post hole diggers, hand or power augers and various other devices none of which can create a specific cavity that meets the stations design specifications.

The unique design of this tool also allows service function soil cavities for installation of cemetery memorial in-ground burial cups. Configuration (FIG. 1, components 1, 2, 4) currently is sized to ensure successful install of the cups. Landscape planting (bulb and plant insertion) is also a prime use for the tool and may also be in other currently undefined service activities.

All that is required of the service technician is to configure the tool to his current service requirements. This can be accomplished by removing one size cutter assembly and install a different one or stacking several cutters if the function requires it This makes a truly one tool concept to replace a number of current used tools in these types of service functions. This single tool of ours will provide many advantages over any other tools that are available today and with its unique design it will greatly improve the quality and productivity of the service personnel that perform these task.

### SUMMARY OF THE INVENTION

It is therefore the object of the present invention to provide certain industry service personnel a tool that will create specific required soil cavities. This invention will satisfy their requirements by providing a single multi-function tool that is configurable, to their specific needs, and will provide a proper and efficient action to satisfy their maintenance and installation requirements.

The designated service activity will be accomplished by the operator placing the tool over the specific target area in the soil and then applying downward clockwise rotating pressure on the upper tool handle assembly. Once operator has reached the proper depth limit of the cutter a continuous upper pressure and clockwise rotating motion on the handle will extract the tool cutter and associated soil contents.

Any of the available cutter assemblies can be utilized independently or together/stacked if required for a specific task. These cutter assemblies are easily installed or interchanged by removing the pin securing the stabilizer sleeve assembly (FIG. 1 Item 2) to the handle shaft and raise it toward the T-handle. This action disconnects the connector pins (FIG. 3, Item 9) from the cutters and allows them to be rotated and disconnected. Once disconnected a different cutter can be rotated on the shaft threads and secured. The tool is designed to include many combinations of cutter sizes in either the top or bottom cutter assembly positions with the only restrictions being the top cutter assembly has to be larger in diameter if used in combination. This single tool can replace a number of tools that are being utilized today such as weed trimmers, shovels, special diggers, spades, manual & powered augers and many other tools used to create cavities in the soil.

In summary, this tool is simple to operate and efficient in its purpose to provide service personnel of a number of different industries a tool that will enhance their productivity and leave the area serviced in a professional appearance.

### BRIEF DESCRIPTION OF THE DRAWINGS

The advantages and specific design features of this multi-function tool invention will be better understood when referenced to the following drawings descriptions and claims that are taken within this document.

FIG. 1 is a perspective view of the Multi-Function Modular Soil Cavity Creator Tool as it would be observed from a side perspective. It displays the t-handle components (1), stabilizer sleeve assembly (2), the primary upper cutter unit (3), lower or possible primary cutter for other applications (4), the optional trimming cutter (5), and the multi-purpose cutter assembly (7) configured for termite bait stations and other assorted functions. Cutter assemblies 4 & 7 can be configured, if required, for standalone tools applications that employ welded T-handles to the cutter assemblies or utilized the flexible connector functions of Items (1 &2) attached to the cutter.

FIG. 2 is a perspective view of the Primary T-Handle assembly. The assembly employs a hollow top steel component welded to the hollow steel shaft assembly. The shaft is connected to the cutter assemblies via a male oriented threaded joint. The shaft assembly incorporates a horizontal hole that secures the shaft to the deployed cutters in a configuration that secures their positions to prevent joint lock when turning the tool to create the cavities. See FIG. 3 for a more definitive explanation of the secure pin slot (4).

FIG. 3 is a perspective view of the service tool Stabilizer Sleeve Assembly. This assembly is unique to this tool design and purpose not utilized in any other tool design known in the industries herein referenced. Its design objective is to provide stability to shaft assembly when rotating and locks cutters joints to the t-handle shaft when rotating and locks cutter joints to the shaft through connector pins (9). This prevents coupler joints from being over tighten.

FIG. 4 is a perspective view of the Soil Cavity Cutter Assembly. This cutter assembly is primarily used to cut the cavity around a sprinkler head assembly for servicing but can be utilized in any service requiring this size cutter for a soil cavity. This view displays the top foot assembly, the three (3) connector pin connector holes, the four (4) cut & elevate fins that create the sprinkler head protector platform on the top of the soil area when the cutter is at depth limit and the tool is rotated, the four (4) staggered cleanout slots item (12) available to assist in soil removal from the cutter if required and the unique array of aggressive lower blades/cutter teeth. This view also displays the cutter connector assembly (10, 11) to attach the assembly to the t-handle shaft threads through the female receptor and provides a lower male component to engage the internal connected lower cutter when used in a stacked configuration. This unique cutter design incorporates unique tool design elements of No. 10, 11,15, 16 and 12 that are is specific to this tool invention and integral to its design function,

FIG. 5 is perspective view of the Sprinkler Head Protector Cylinder. This cutter has the primary function of being inserted over the sprinkler head assembly when the cavity is being created. It allows the sprinkler head assembly not to drag or pull the captured soil out of the main cutter assembly when withdrawn from the cavity. It has most of the design features included in FIG. 4. They include Items 21, 22, 24, 18, 19 and 20. This assembly also has a number of secondary uses for termite bait stations, landscape planting and others when connected to FIG. 1 items 1&2

FIG. 6 is a perspective view of the Irrigation Trimming Cutter Assembly that illustrates the full view of its components. The assembly includes foot plate (27), upward and lower coupler connectors (28 & 25) that attach the coupler to the shaft assembly and couples lower cutters when used in a stacked configuration. Item (30) is an unique cutter scalloped blade design that will cut/trim most known vegetation overgrowth around sprinkler head protectors and special golf course rotating irrigation assemblies.

FIG. 7 is a perspective view of a Cavity Cutter Assembly (Cutter Sized to Requirements). This assembly incorporates all of the design features used in FIG. 1 Items 3, 4. This cutter can be in a permanent tool configuration if T-handle FIG. 1 Item 1 is welded to the cutter or it can be connected through the handles male threads if used in a stacked configuration.

This modular flexibility is what makes the design of this tool so unique when you have an almost unlimited array of choice in configuring service soil cavity creator tools.

### DETAILED DESCRIPTION OF THE DRAWINGS

The exemplary embodiments of this invention, that have been described herein, are subject to variations in applications of the design and basic structure. However, it should be noted that the particular design, as described, is intended to cover the application or implementation of this design and its unique components without departing from the spirit and claims made herewith in. It is understood that various omissions and substitutions of equivalents are contemplated as events may suggest or render expedient, but the description is intended to cover the design without departing from the scope or The terms primary, secondary, first, second or the like do not necessary denote order of importance, quality or quantity but rather are used to distinguish one component or action from another.

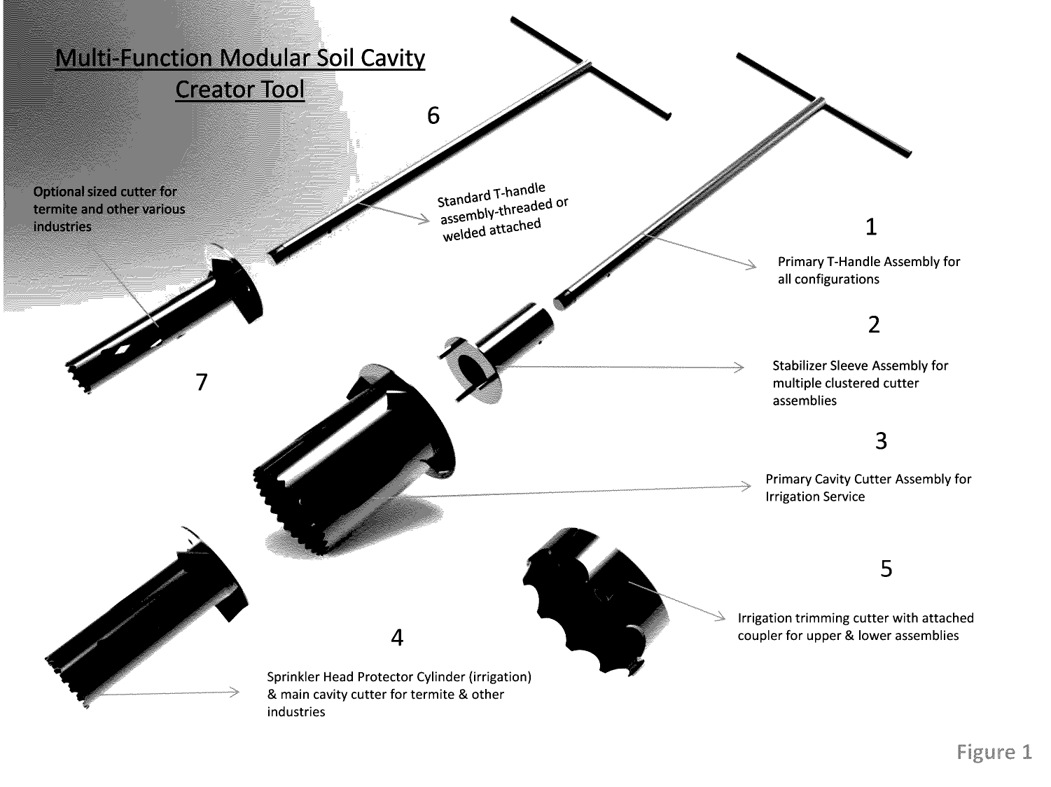

The present invention provides a method for service personnel, in certain industries, to create cavities in the soil to satisfy specific service action requirements. The tool provides cavity cutters that contain unique design components qualities that allow service personnel to create specific size cavities using a variety of specific tool configuration to satisfy the needs of their specific services task. In FIG. 1 you have a graphical representation of the primary and several optional components of the Multi-Function Modular Soil Cavity Creator Tool. In the drawing one of the primary configurations would be the connection of Items 1, 2, 3, & 4 to configure a tool for creating a service cavity around a sprinkler head assembly for repair or replacement With this combination the service technician would place item 4 cutter over the target sprinkler head and then begin to exert down pressure and clockwise rotation of the handle assembly. The tool would begin to cut the soil and continue downward to the depth limit is attained. This depth limit is predetermined by the size and type of sprinkler heads assemblies used in this specific system. This is necessary especially to prevent damage to the sprinkler systems water supply PVC pipes. Once depth limit is reached the technician will begin an upward and clockwise rotation of the tool until it is removed from the cavity. At this point we have a cavity that show the sprinkler head with all soil removed down to the supply pipe coupler. At this point the technician will counter clockwise the sprinkler head assembly until it decouples from the supply coupler. The technician then inserts a new head in the cavity, turns clockwise until tight on water supply coupler. This completes the replacement phase. At this juncture the technician take a soil clean out tool, inserts it in easy soil cleanout cutter slots while over the cavity. This action pushes the original removed soil from the cutter and the technician hand packs the removed soil around head assembly. Service completed. One important point in this particular design/configuration is the use of the Sprinkler Head Protector Cylinder in the configuration. This cylinder prevents damaging the sprinkler head assembly and also prevents the head assembly from dragging all of the captured soil back in the cut cavity which nullifies the effectiveness of the cutters intention to cut and removed the sod/soil from the cavity.

Another embodiment of the tool would be the deployment items 1, 2 and 5 in FIG. 1. This combination of components would provide a specific service function of various sprinkler system components. One major issue with in-ground sprinkler systems is the growth of vegetation and soil collection over the assembly ground level which in many cases causes failure of the assembly. To correct it a service technician must employ some type of device to remove such obstacles. The above configuration when placed over the assembly area and rotated in downward and clockwise direction will cut all vegetation and when extracted from the cavity, that was created, will remove all soil and cut vegetation from the area. The unique design of the special scalloped cutter blades make this exercise most successful.

The combination of FIG. 1 items 1, 2, and 4 or 7 also create a unique configuration that is exact in specification required by the pest control industry for termite eradication. The industry will utilize, as part of the termite detection and eradication process, in-ground termite bait stations that include active chemical and wood fiber bait ingredients. These stations are placed approximately ten (10) feet apart around the structure outer walls. The tool as configured above will be placed over a specific target areas location for the installation of the bait stations. Once the tool is placed over the target the technician will begin to place downward pressure on the t-handle and begin to rotate clockwise. This motion will go to the depth determined by the position of the top plate on the cutter. At this point the upper cut & elevate fins will begin to cut a platform on the soil surface that is required for the station to rest. At this point the station is placed into exact cavity and downward pressure is exerted until top platform is resting on the soil. This completes the installation sequence for the stations.

There are many other configuration uses that can be derived from this tool for other services but in general they follow the same operational sequences as described in other events above.

FIG. 1 Multi-Function Modular Soil Cavity Creator Tool as described above defines the components of the tool in an exploded view and their basic function in detail notes.

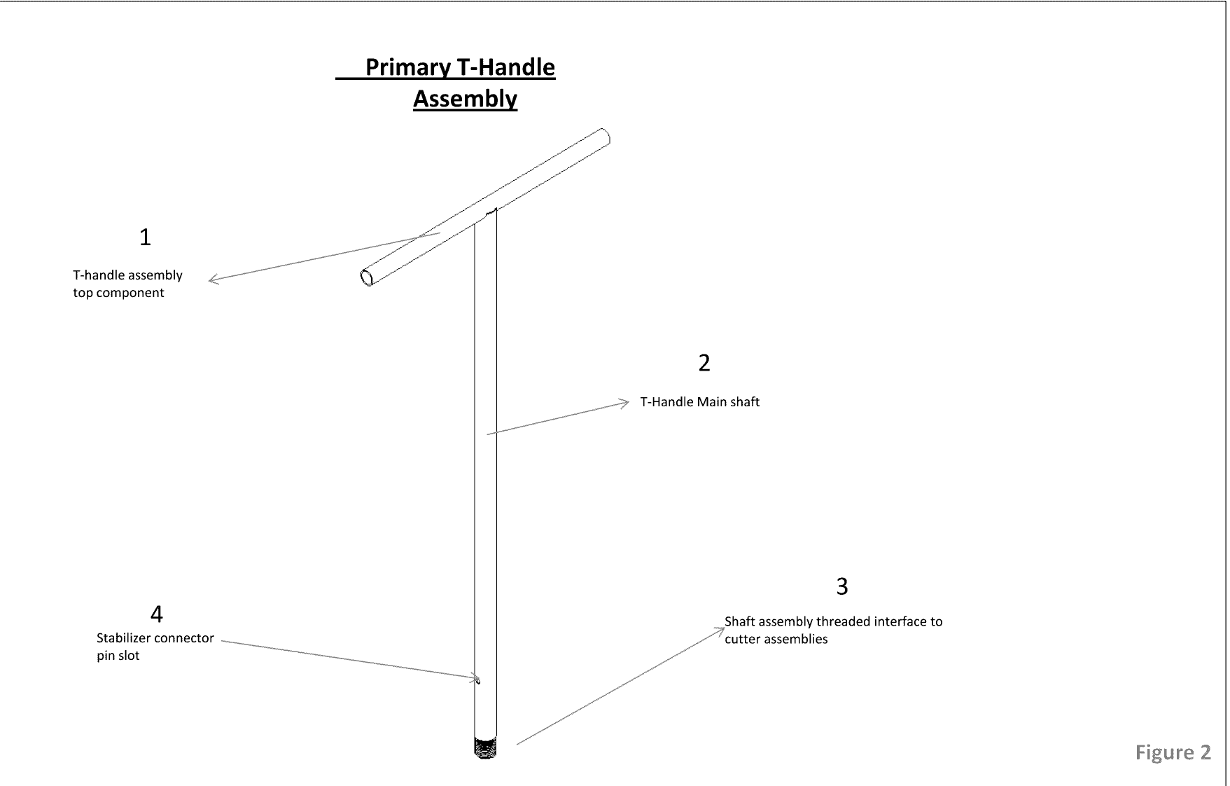

FIG. 2 is a perspective view of the Main T-Handle Assembly. This assembly is the primary components for the different configurations of the tool to be configured as a single defined tool. It contains four (4) specific features. First is the top component of the t-handle assembly. This component is constructed of hollow steel tubing of a size required to accept sufficient force without changing shapes.

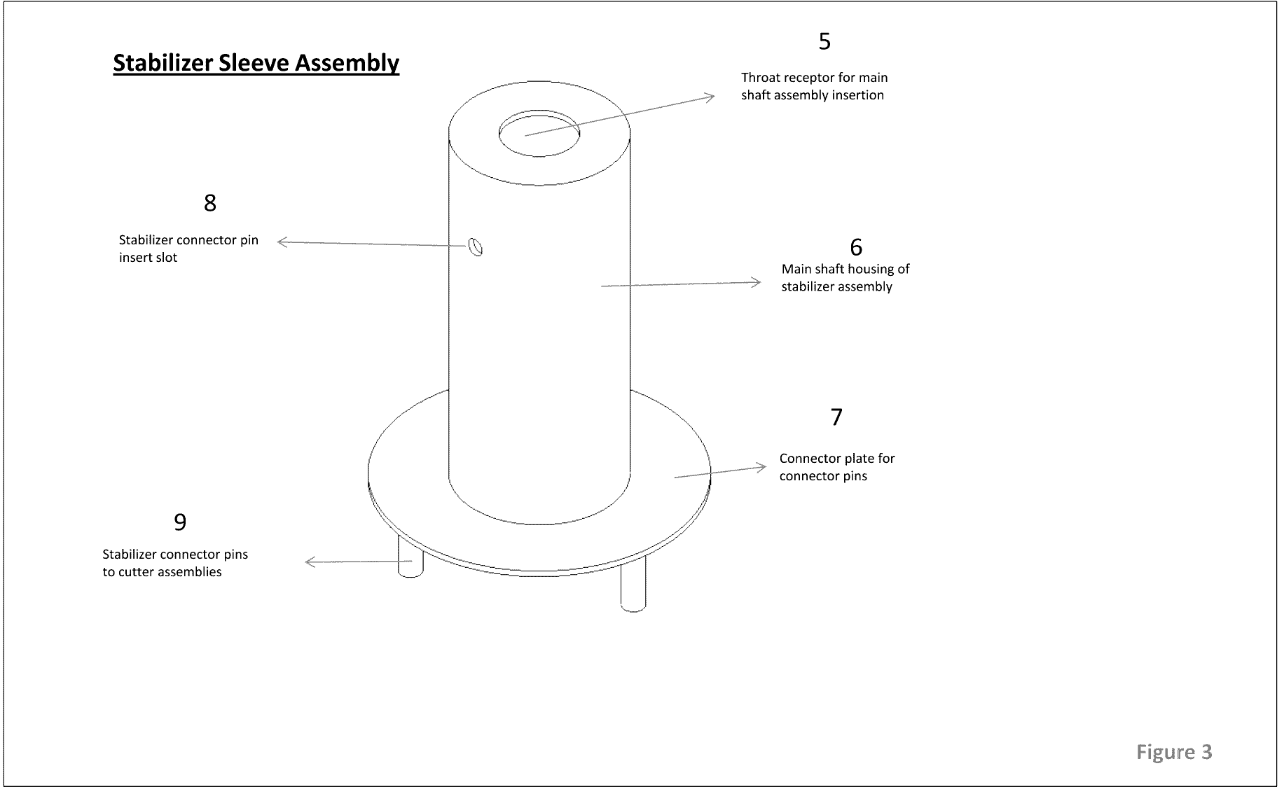

This material is the same that is employed for the t-handle shaft component The top component is welded to the shaft component forming a solid unit that will drive the tools different configuration requirements. The shaft will include a male oriented thread on the component end of the shaft that will be used to connect the lower components that form the configured tool. The other design component is a pinhole item (4) drilled horizontally in the shaft at a designated point that will allow a connector pin to be inserted into and lock the stabilizer sleeve assembly FIG. 3 to the shaft assembly.

FIG. 3 herein after referred to as the Stabilizer Sleeve Assembly. This assembly is a unique design that was created to perform several functions. First when installed over the t-handle shaft assembly it will be connected to the shaft assembly as described in FIG. 2 above. Once a cutter or stacked cutters are threaded onto the t-handle shaft the stabilizer connector pins (9) will engage and penetrate the receptor holes in the individual cutter top plates. When one plate or multiple are secured by the pins the t-handle is turned counter clockwise to align the connector pin insert slot hole in the shaft to the pin hole in the sleeve assembly item (8). At this time the pin is inserted and locked in place on the sleeve assembly. This locking action freezes the cutter/s alignment to the shaft and will prevent joint freeze from over tightening the threads. Additionally, the stabilizer sleeve assembly provides a vertical support framework that will prevent the shaft from buckling on the shaft when large amount of force is required to turn the t-handle assembly while cutting through soil to create the cavity.

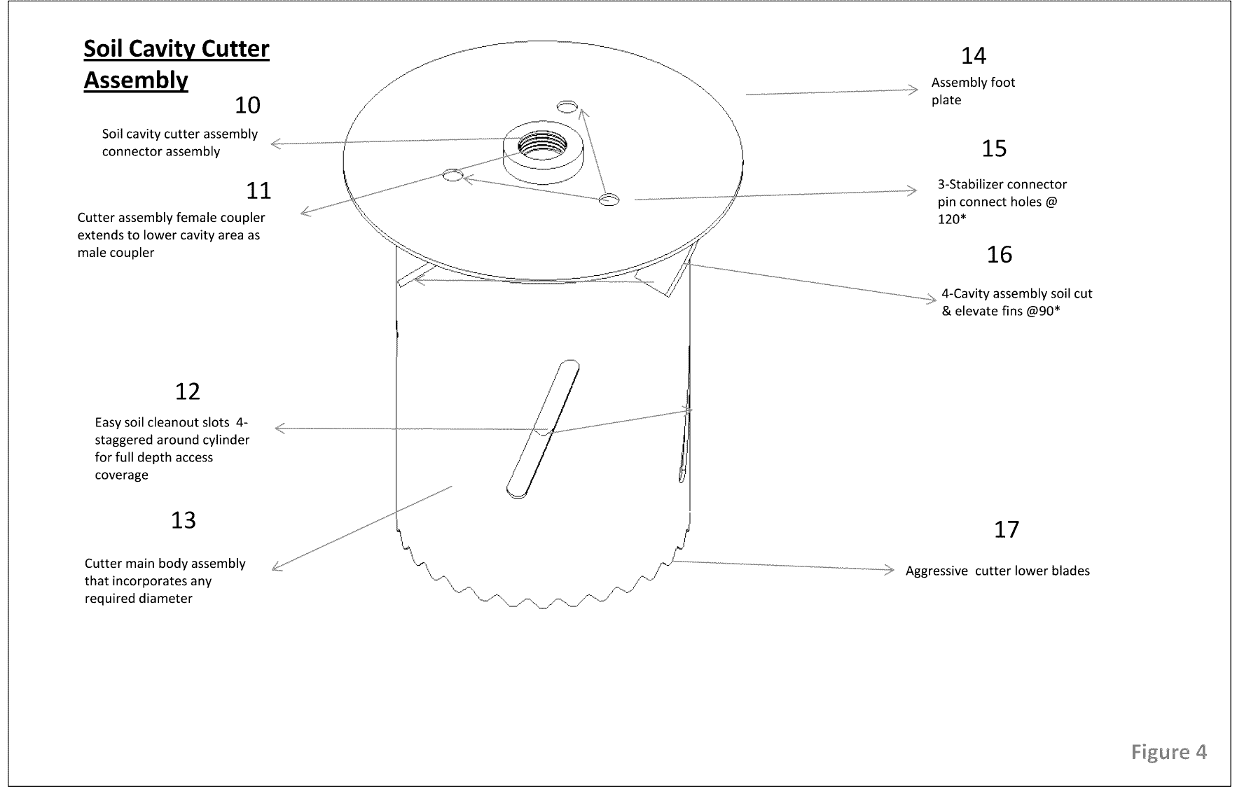

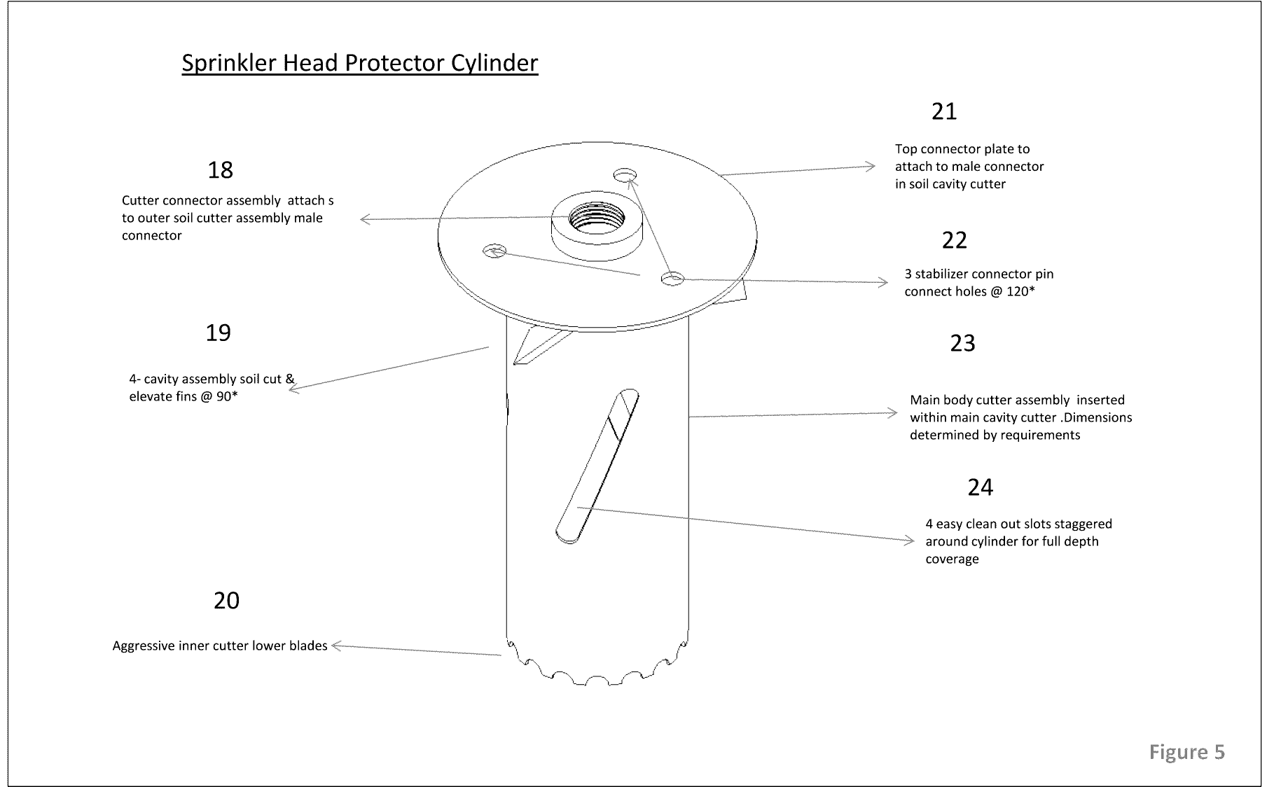

FIG. 4 illustrates a sheet of steel (13) formed to create a circular cylinder that forms the cutters main body assembly that is suitable to withstand the riggers of boring a cavity in the soil when torque is being applied by the rotation of the t-handle. The body will contain an aggressive set of teeth that is heat treated to harden the metal that will be necessary to allow the assembly to bore through, in many cases small rock, roots, other foreign material and the soil to create the cavity. The Soil Cavity Cutter Assembly incorporates a number of unique design qualities not found in other tools used to create holes in the soil. The assembly is attached to the T-handle male threads using a threaded female oriented connector (10) that extends through the top plate assembly (14) to allow the attachment of an inner cutter such as FIG. 5) Sprinkler Head Protector Cylinder. This extension is a male oriented thread that allows additional cutters to form a stack for other applications. Item (14) is a unique design component in which this cutter is locked in place by the insertion of connector pins FIG. 3 item 9. These connector pins are aligned and inserted in the three (3) connector holes item (15) located in the top plate assembly. This connection is then coupled to the shaft assembly FIG. 1 through a connector pin inserted in slot (8) in FIG. 2. This locking of components is designed to protect the couplers threaded joints and to keep the relationship of t-handle and cutters frozen to stop joint lock//over tighten of joint. Item (16), is another key feature of the cavity cutter, these four (4) cavity assembly cut & elevate fins are unique to any hole cutter design and are used to create a clean round surface soil platform for the placement of the sprinkler head ground protectors. They are commonly used to protect the sprinklers from lawn mowers and other forces. During the process of cutting a cavity soil is accumulated in the cutters body assembly when extracted from the cavity and depending on type of soil the gentle shaking of the cutter may not be sufficient to remove the soil. The placement of the four (4) easy soil cleanout slots allow the technician to insert a flat tool type device in any of the slots and push the soil from the unit. Many of the design features explained herein are present on the entire cutter configuration such as FIGS. 5-7. This enhances the usability and configurations of this tool and its design.

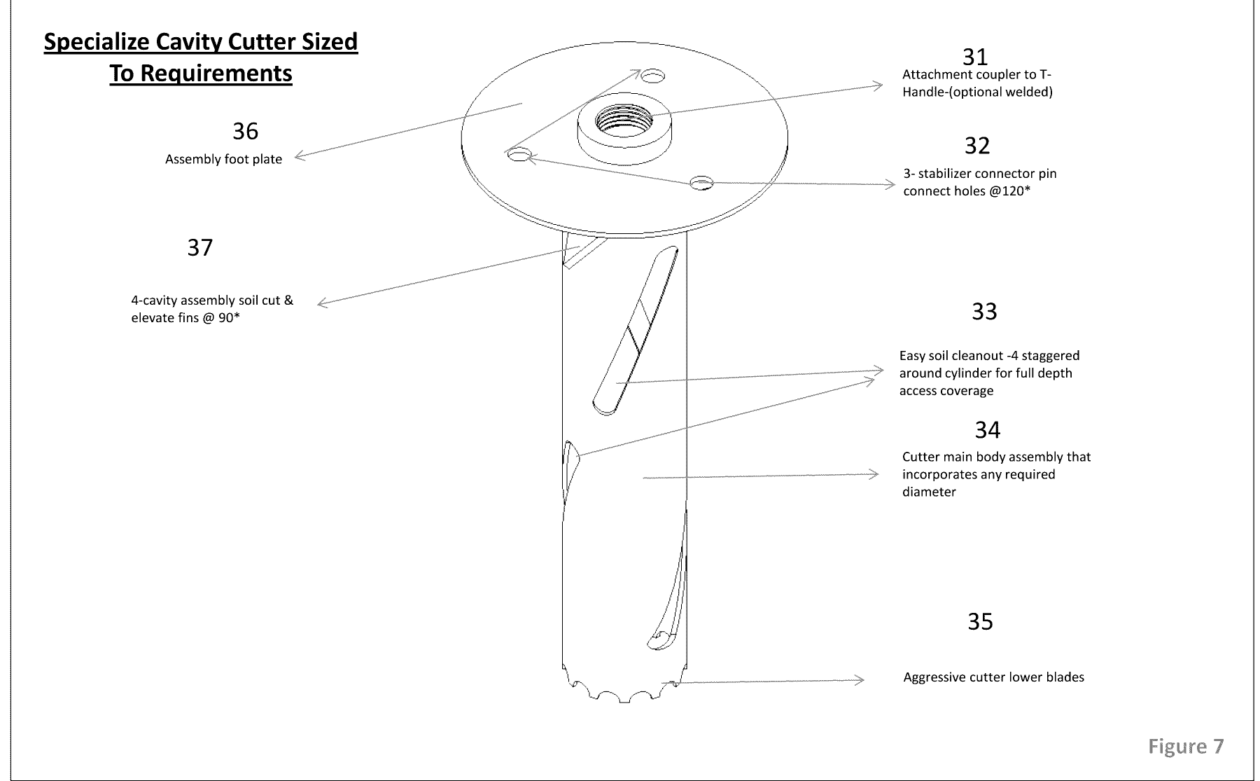

FIG. 5 & FIG. 7 illustrations depict components of the design that are a direct replica of FIG. 4 in all aspects of design and content except cutter cylinders. The primary difference in these units, when compared to FIG. 4, is the dimensions of the cutter main body in length and diameter. This is a major concept advantage of this total design in which the tool in a few steps can become a primary cavity creator cutter for a totally different services such as irrigation vs. termite bait stations.

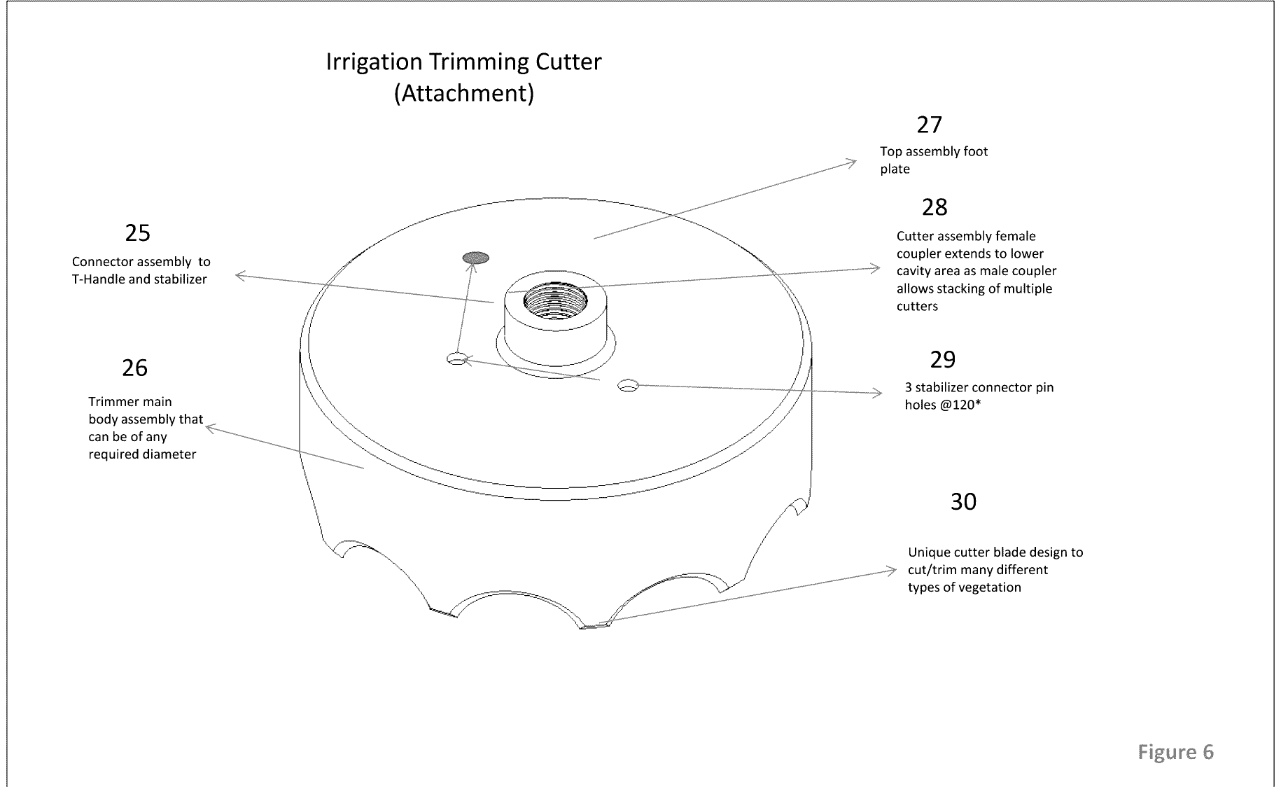

FIG. 6 illustrates a cutter comprised of a top plate assembly of steel used for a foot plate and connector assembly. This top plate contains assembly (25) which is of female orientation and of exact dimensions, as all other cutter tool assemblies and will directly thread on to the t-handle assembly FIG. 2. In a specific service action that requires multiple/stacked cutters i.e., sprinkler head repairs, the connector (28) which is a lower extension of component (25) is used to mount the next sub or second level of cutter assembly. Located also in top plate assembly (27) is Item (29) which is the receptor pin holes that are for the insertion of the connector pins from FIG. 3 connector pins (9). These connector pins when inserted will freeze the location of the t-handle threads to the cutter assembly coupler. Assembly also includes items (26) which is a sheet of steel formed in an circle and welded to the top plate and forms the cutters side frame. This side assembly contains aggressive teeth configuration specifically designed to cut thru most types of vegetation that surrounds sprinkler assemblies regardless of location. This cutter when used at large areas of sprinklers systems such as golf courses may also create a single purpose tool configuration containing the cutter FIG. 1 item 5 and T-Handle FIG. 1 item 1 welded instead of utilizing the threaded couplers.

1. An apparatus that is configurable to provide a number of specific soil cavity tools that are unique/required by a multitude of major industries. Industries like irrigation, pest control, landscaping, cemetery/burial and a number of others that have a need to create soil cavities as part of their service business. This tool is capable of creating a cavity in the soil of various dimensions that is determined by the length and diameter of the cutter assembly and leaving the surrounding service area clean. This is very different from the tools that are commonly used by those industries today.
A handle having a T shape, a pin slot for locking the stabilizer sleeve unit and contains a male oriented thread on opposite end.
A stabilizer sleeve assembly that locks the handle to the various cutter assemblies that prevent the over tightening of the threaded couplers during the rotation and cutting actions of the cutters. Sleeve prevents any twisting/deforming of the handle assembly joints by locking side motion of the handle assemble. The stabilizer is attached to the shaft assembly through the use of a pin inserted horizontally through the sleeve and handle.
A female oriented threaded coupler assembly located on each cavity cutter top plate that attaches to the threaded male coupler on the t-handle or the male connector located within the upper target cutter. This threading action locks the cutter to the specific configured tool desired components. The cutter coupler opposite end extents downward and internal to the cutter housing and is of a male persuasion that will be the attachment coupler for any lower added in a stacked configuration.
A cavity cutter assembly that will be attached to the t-handle male threads to its female receptor coupler assembly and be attached to the sleeve assembly through the insertion of connector pins in the top plate assembly receptor holes.
A steel body of possible different sizes that will contain aggressive cutter teeth blades that are heat treated for lasting strength, body contains staggered easy soil clean out slots that allow a flat blade object to be inserted to assist in soil removal.
A group of special designed steel blades attached/welded to the top plates underside and cutter body assembly and angled at 90* degrees. These cut & elevate blades will slice the soil at the top of the cavity to form a platform surface to allow the sprinkler protector and termite bait stations to rest at ground level as required to accommodate the sprinkler head protectors that are used to prevent damage as the result of lawn equipment such as lawnmowers hitting the head assembly.
